(19) United States
(12) Patent Application Publication
(10) Pub. No.: US 2012/0207923 A1
(43) Pub. Date: Aug. 16, 2012

(54) Method for Coating a Silicate Flourescent Substance

(76) Inventor: Alexander Baumgartner, Ingolstadt (DE)

(21) Appl. No.: 13/501,658

(22) PCT Filed: Oct. 6, 2010
(86) PCT No.: PCT/EP2010/064913

§ 371 Date: Apr. 12, 2012

(30) Foreign Application Priority Data
Oct. 12, 2009 (DE) 10 2009 049 056.6

(51) Int. Cl. B05D 5/06

(52) U.S. Cl. 427/162

(57) ABSTRACT

A method for producing a coating on a silicate phosphor, comprising the steps of preparing a solution of a precursor of the coating material; depositing the coating material on phosphor particles introduced into the solution; and heat treatment in an oxidative atmosphere at temperatures of at least 150° C.

### TECHNICAL FIELD

The invention relates to a method for coating a silicate phosphor as claimed in the preamble to claim 1. The method can be used in particular for orthosilicates or nitrido-orthosilicates.

### Prior Art

EP 1 199 757 discloses a coating for phosphors, in particular for orthosilicates. In particular, SiO₂ is used.

### SUMMARY OF THE INVENTION

An object of the present invention is to specify a method whereby the stability of orthosilicate phosphors can be improved in a simple manner.

This object is achieved by the characterizing features of claim 1.

Particularly advantageous embodiments are set forth in the dependent claims.

For many applications, including LCD backlighting, LUCOLEDs are needed, the implementation of which requires suitable conversion materials emitting in both the red and the green region of the visible spectrum. LUCO here means luminescence conversion. In conjunction with the emission wavelength of the semiconductor chip, as extensive a color space as possible is to be mapped. A suitable phosphor class are green-emitting (nitrido-)orthosilicates AE₂₋ₓ₋ₐREₓEuₐSiO₄₋ₓNₓ (AE: Sr, Ca, ea, Mg; rare earth metals (RE): particularly Y, La), as they have a suitable emission wavelength and good conversion efficiency. The disadvantage of the (nitrido-)orthosilicate phosphors is their inadequate stability against external chemical influences such as an acidic environment or (atmospheric) humidity. This results in degradation of the phosphor in the LED during use, thereby adversely affecting the conversion efficiency in the green spectral range and therefore the chromaticity coordinate of the LED.

Currently there is no known green-emitting phosphor to compete with (nitrido-)orthosilicate phosphors in terms of conversion efficiency. As phosphor degradation adversely affects the use of this class of phosphors in LUCOLEDs, it has been attempted to improve stability intrinsically by varying the stoichiometry, primarily the ratio of alkaline earth ions. However, this has not enabled a sufficient degree of stability to be achieved for this application. Moreover, varying the stoichiometry in respect of intrinsic stabilization adversely affects the emission wavelength of the phosphor.

The inadequate chemical stability of (nitrido-)orthosilicate phosphors can be significantly improved using surface modification, thereby avoiding the detrimental effects of intrinsic stabilization. By applying an inorganic hydroxide layer, e.g. Al(OH)₃, Y(OH)₃ or Mg(OH)₂, an inorganic oxide layer, e.g. Al₂O₃, Y₂O₃, MgO or with particular preference SiO₂, or mixed forms of the two substance classes to the surface of the phosphor particle, complete enveloping of the phosphor core is achieved. A barrier effect is produced which significantly inhibits chemical attack on the particle core critical to conversion efficiency, resulting in greatly reduced degradation of the orthosilicate phosphor.

This diffusion barrier is applied by deposition from a solution of the coating precursors, preferably by hydrolysis and subsequent condensation of metal alkoxides or metal alkyls, preferably tetraethoxysilane (TEOS), as basically described in the literature (e.g.: W. Stober, A. Fink, E. Bohn, J. Colloid Interface Sci. 1968, 26, 62-69). In addition, a slight supersaturation in solution is ensured by a low rate of addition of the coating precursors, so that nucleation in a separate phase is reduced and deposition on the surface of the phosphor particle is promoted.

Of critical importance for the quality of the coating as a diffusion barrier is subsequent heat treatment in an oxidative atmosphere at temperatures of 150-500° C. for 0-20 h, preferably at 200-400° C. for 2-10 h (cf. FIG. 1), so that complete dehydration, consolidation of the deposited layer and removal of organic residues can be achieved.

### BRIEF DESCRIPTION OF THE DRAWINGS

The invention will now be explained in greater detail with reference to a number of exemplary embodiments and the accompanying drawings in which:

FIG. 1 shows a semiconductor component used as a light source (LED) for white light;

FIG. 2 shows a lighting unit with phosphors according to the present invention;

FIG. 3 shows the minimizing of the thermal damage of the phosphor during the bake-out step necessary for stabilization as a function of bake-out time and temperature;

FIG. 4 schematically illustrates a coated phosphor

### PREFERRED EMBODIMENT OF THE INVENTION

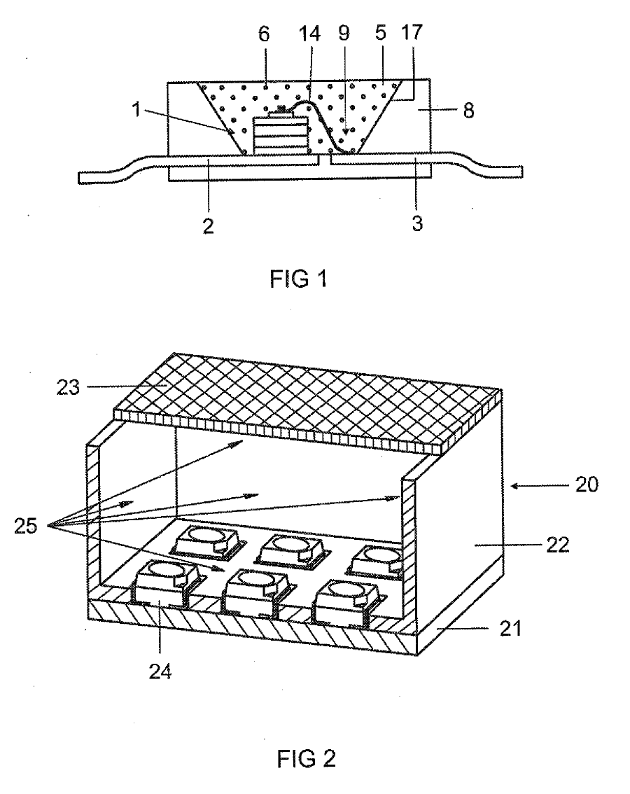

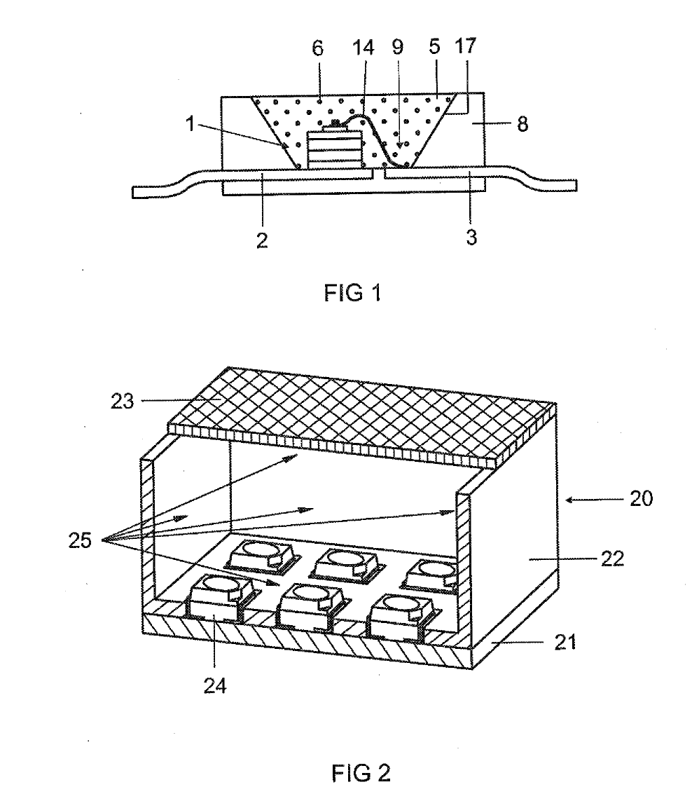

For use in a white LED in conjunction with a GaInN chip, a design similar to that described in U.S. Pat. No. 5,998,925 is typically employed. The design of such light source for white light is explicitly depicted in FIG. 1. The light source is an InGaN type semiconductor component (chip 1) with a peak emission wavelength of 460 nm comprising a first and second electrical lead 2,3, said component being embedded in an optically opaque basic housing 8 in the region of a recess 9. One of the leads 3 is connected to the chip 1 via a bond wire 14. The recess has a wall 17 which is used as a reflector for the blue primary radiation of the chip 1. The recess 9 is filled with an encapsulation material 5 containing silicone resin (70 to 95 wt. %) and phosphor pigments 6 (less than 30 wt. %) as its main constituents. Other small amounts of, among other things, Aerosil are also present. The phosphor pigments are a mixture of a plurality of pigments, here primarily orthosilicates or nitrido-orthosilicates.

FIG. 2 shows part of a light panel 20 as a lighting unit. It consists of a common carrier 21 onto which a box-shaped outer housing 22 is glued. Its top side is provided with a common cover 23. The box-shaped housing has recesses in which individual semiconductor components 24 are accommodated. These are UV-emitting LEDs with a peak emission of 380 nm. The conversion into white light takes place using conversion layers located directly in the encapsulating resin of the individual LEDs in a similar manner to that described in FIG. 1 or layers 25 which are applied to all the surfaces accessible to the UV radiation. These include the inner surfaces of the housing sidewalls, cover and base section. The conversion layers 25 consist of three phosphors which emit in the red, green and blue region of the spectrum using the phosphors according to the invention. Alternatively, a blue-emitting LED array can be used wherein the conversion layers can consist of one or more phosphors according to the invention, particularly phosphors which emit in the green and red spectral range.

To coat a (nitrido-)orthosilicate phosphor, 20 g of phosphor were suspended in 173 ml of ethanol and 14.7 ml of deionized water. Ultrasound was applied for 5 minutes for better dispersion. Coating is performed by slowly stirring 2.2 ml of TEOS into 22 ml of EtOH at 30 min intervals at 60° C. The TEOS is added up to a total volume of 14.8 ml. After cooling of the suspension, the coated phosphor is removed from the reaction mixture, washed with water and ethanol and dried for 12 h at 60° C. To ensure complete dehydration and consolidation of the coating, it is then air baked for 5 h at 350° C.

The procedure described produces a dense, closed coating of SiO₂ on the particle surface.

Compared to uncoated phosphors, the (nitrido-)orthosilicate phosphors prepared by coating with inorganic oxide layers, preferably SiO₂, have greatly improved stability against acidic and humid environments. A qualitative demonstration of this significantly reduced sensitivity to acids and hydrolysis is to suspend the phosphor in an acidic buffer solution pH=4.75 (equimolar 0.1 M acetic acid/acetate buffer, phosphor concentration 1%). Compared to the uncoated phosphor, the time to constant conductivity of the solution, as an indicator of complete hydrolysis of the phosphor, can be increased by a factor of 20 by the coating. Consequently, the hydrolytic stability of the (nitrido-)orthosilicates has been significantly improved by the coating described here.

In contrast to intrinsic stabilization, the advantage of the invention described is primarily that stabilization is possible without varying the composition of the phosphor material. Varying the composition for the purpose of intrinsic stabilization always results in mainly undesirable changes in the luminescence properties of the orthosilicate phosphors, above all in the emission wavelength critical for use in LUCOLEDs. By contrast, the stabilization described here involving the application of an oxide layer has no effect on the luminescence properties.

Rather, the described method of stabilization makes it possible for the composition of the (nitrido-)orthosilicates to be optimized in respect of their luminescence properties and then stabilized by the method described here. The combination of efficient (nitrido-)orthosilicate phosphors, the applied coating and the subsequent bake-out process therefore results in significantly improved green-emitting (nitrido-)orthosilicate phosphors for LED use.

In particular, M2SiO4:Eu with M=Ba, Sr, Ca, Mg is used alone or in mixture as the phosphor. Another class of suitable phosphors is M-Sion of the type M2SiO(4-x)Nx:Eu, again with M=Ba, Sr, Ca, Mg alone or in mixture. Another suitable phosphor class is phosphor of the type M2-xRExSiO4-xNx:Eu, where the rare earth metal RE is preferably Y and/or La. Another formulation of this phosphor is M(2-x-a)EuaRExSiO(4-x)Nx.

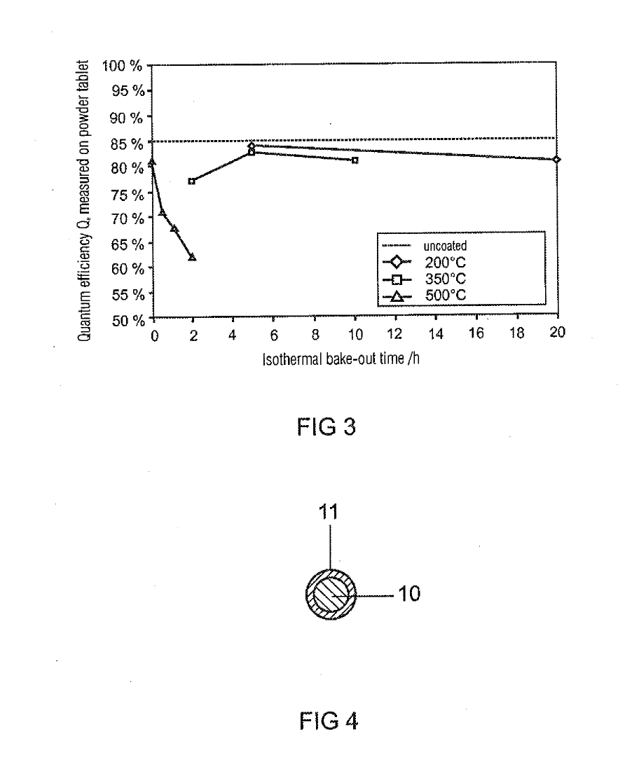

FIG. 3 shows the quantum efficiency Qe measured on a powder tablet in percentage terms for various temperatures from 200 to 500° C. as a function of bake-out time.

FIG. 4 schematically illustrates a coated phosphor particle. The particle 11 of (Sr,Ba)2SiO4:Eu is surrounded by an approximately 0.2 μm thick protective coating of SiO2 deposited using the above method.

The positive effect of bake-out emerges in particular from the following comparisons according to Tables 1 and 2. It should be noted in particular that the pure SiO2 coating actually appears to have a destructive effect in the LED application, and it is only through the additional bake-out step that a significant improvement is achieved even compared to the phosphor without coating, see Table 2.

### Essential Features of the Invention in the Form of a Numerical Listing are:

1. A method for producing a coating on a silicate phosphor, characterized in that the following process steps are used:
   preparing a solution of a precursor of the coating material;
   depositing the coating material on phosphor particles introduced into the solution;
   heat treatment in an oxidative atmosphere at temperatures of at least 150° C.
2. The method as claimed in claim 1, characterized in that the deposition is carried out by hydrolysis and subsequent condensation of metal alkoxides or metal alkyls.
3. The method as claimed in claim 2, characterized in that during deposition a slight supersaturation in solution is ensured by a low rate of addition of the coating material precursor of no more than 250 mmol/L metal cation per hour, preferably no more than 150 mmol/L.
4. The method as claimed in claim 1, characterized in that inorganic hydroxide, particularly of the metals Al, Y or Mg, is used as the coating material.
5. The method as claimed in claim 1, characterized in that oxide, particularly of the metals Al, Y or Mg, or SiO2 is used as the coating material.
6. The method as claimed in claim 1, characterized in that oxide and hydroxide in mixed form are used as the coating material.
7. The method as claimed in claim 1, characterized in that the heating step takes place at temperatures of 200 to 500° C., in particular 300 to 400° C.
8. The method as claimed in claim 7, characterized in that the heating step maintains a temperature of at least 200° C. over at least one hour.

TABLE 1
Hydrolytic stability of uncoated/coated
orthosilicate phosphors in acidic suspension.
Table 1_Hydrolytic stability of uncoated/coated
orthosilicate phosphors in acidic suspension.

| | Time to constant | |
|---|---|---|
| Phosphor | conductivity | |
| Uncoated orthosilicate | 39 | s |
| phosphor | | |
| SiO₂-coated | >30 | min |
| orthosilicate phosphor | | |

TABLE 2
Degradation of orthosilicate phosphors in LED use.

| | Emission_intensity ratio |
|---|---|
| | phosphor/LED-chip after 1000 |
| Orthosilicate phosphor | min. operating time |
| Uncoated | 91.1% |
| SiO₂-coated | 82.0% |
| SiO₂-coated and baked | 98.8% |
| out (350° C., 5 h) | |

1. A method for producing a coating on a silicate phosphor, comprising the steps of:
preparing a solution of a precursor of the coating material;
depositing the coating material on phosphor particles introduced into the solution; and
heat treatment in an oxidative atmosphere at temperatures of at least 150° C.

2. The method as claimed in claim 1, wherein the deposition is carried out by hydrolysis and subsequent condensation of metal alkoxides or metal alkyls.

3. The method as claimed in claim 2, wherein during deposition a slight supersaturation in solution is ensured by a low rate of addition of the coating material precursor of no more than 250 mmol/L metal cation per hour.

4. The method as claimed in claim 1, wherein inorganic hydroxide is used as the coating material.

5. The method as claimed in claim 1, wherein oxide or SiO2 is used as the coating material.

6. The method as claimed in claim 1, wherein oxide and hydroxide in mixed form are used as the coating material.

7. The method as claimed in claim 1, wherein the heating step takes place at temperatures of 200 to 500° C.

8. The method as claimed in claim 7, wherein the heating step maintains a temperature of at least 200° C. over at least one hour.

9. The method as claimed in claim 2, wherein during deposition a slight supersaturation in solution is ensured by a low rate of addition of the coating material precursor of no more than 150 mmol/L metal cation per hour.

10. The method as claimed in claim 1, wherein inorganic hydroxide of the metals Al, Y or Mg is used as the coating material.

11. The method as claimed in claim 1, wherein oxide of the metals Al, Y or Mg is used as the coating material.

12. The method as claimed in claim 1, wherein the heating step takes place at temperatures of 300 to 400° C.
